(19) United States
(12) Patent Application Publication
(10) Pub. No.: US 2015/0379590 A1
(43) Pub. Date: Dec. 31, 2015

(54) METHODS AND SYSTEMS FOR ALIGNING PRINCIPALS AND AGENTS OF SOCIAL GOOD

(71) Applicants: Tess P. MICHAELS, Plano, TX (US); Max P. MICHAELS, Plano, TX (US)

(72) Inventors: Tess P. MICHAELS, Plano, TX (US); Max P. MICHAELS, Plano, TX (US)

(73) Assignee: SOCEANA LLC, Plano, TX (US)

(21) Appl. No.: 14/844,560

(22) Filed: Sep. 3, 2015

Related U.S. Application Data
(63) Continuation-in-part of application No. 14/498,226, filed on Sep. 26, 2014.
(60) Provisional application No. 61/993,320, filed on May 15, 2014.

(51) Int. Cl. G06Q 30/02; G06Q 30/00; G06Q 40/00

(52) U.S. Cl. CPC G06Q 30/0279; G06Q 40/125; G06Q 30/018

(57) ABSTRACT

The present invention provides a system for managing charitable funds and social currencies in the ecosystem of principals such as corporations and philanthropists, and agents such as volunteers and non-profit organizations that do social good. Principals cause to issue a finite number of social currency units, with varying conditions on use. These units are transferred to volunteers who are supporting a non-profit organization corresponding to the volunteer hours spent by each. The earned units may be gifted by each volunteer to any non-profit organization. Alternatively, the units may be directly granted to a non-profit by corporations and philanthropists corresponding to the units earned by each volunteer. The non-profits voluntarily accept the units and spend it to generate social good. These new methods to pledge, sponsor, configure, issue, denominate, value, track, earn, buy, store, gift, redeem, sell and spend the social currency units create a vibrant community that multiplies the social good generated.

### CROSS-REFERENCE TO RELATED PATENT APPLICATIONS

This application is a continuation-in-part of U.S. application Ser. No. 14/498,226, filed Sep. 26, 2014, which in turn claims of the benefit of priority from U.S. Provisional Application Ser. No. 61/993,320 filed May 15, 2014, the entireties of which are hereby incorporated herein by reference.

### FIELD OF THE INVENTION

The present invention generally relates to the market for social good, an eco-system of principals such as corporate and individual philanthropists, and agents such as non-profits and volunteers who partake in social initiatives. In particular, the invention relates to a system and methods to multiply the effect of the charitable contributions by creating social incentives to collaborate for principals and agents of social good. It includes implementing an alternative currency ecosystem in the market for social good. These new methods to pledge, sponsor, configure, issue, denominate, value, track, earn, buy, store, gift, redeem, sell and spend the alternative currency units strengthen the linkages among the stakeholders in unique ways, and multiply social good.

### BACKGROUND

Social good is a service that benefits a large section of the society, especially, the economically and socially challenged sections of the society. The active participants in generating social good are principals such as corporations and individual philanthropists who sponsor the resources, and agents such as volunteers and non-profit organizations who actively generate social good. Philanthropists provide charitable donations to various non-profit organizations, directly or through their foundations. Corporations contribute toward social good through their Corporate Social Responsibility (CSR) programs. The corporations generally work with non-profit organizations as a part of their CSR activities. Further, the corporations may be specific regarding the type of cause they want to contribute to. Non-profits use the funds received from these principals to organize social good initiatives by acquiring resources and employing people. The majority of non-profit work, however, is carried out through volunteers. These humanitarians work for the non-profit organizations without pay, and contribute towards social good with their time and efforts. Majority of these volunteers also make charitable contributions to the causes they support.

Gallup reported that over 80% of American taxpayers donate to charity. Giving USA Foundation reported that America is the most charitable nation in the world with an increasing share from Corporations and Philanthropic Foundations. Americans also contributed their time for charitable and social causes. A Gallup poll showed that over 60% of Americans volunteer at various non-profits. These humanitarians collectively spent over eight billion hours every year volunteering at non-profits.

Thus US corporations and philanthropists are committed to social and charitable causes. However, an analysis of the social good domain highlights critical gaps in terms of quantity as well as quality across various sectors thereof. A quantity gap arises when there is a mismatch between demand and supply. For example, sectors such as malnutrition, water, and rural infrastructure have a high demand but the supply of funds is low. In some sectors such as primary education and maternal care, the demand and supply is matched but the outcomes are of low quality leading to a quality gap. Thus, there is a need to direct and provide an engagement platform that guides the principals to pledge contributions to the essential sectors using reliable, real-time analysis, to deliver a larger impact in the society.

At times, people with a desired skill set, eager to use their skills in the social good domain, are unable to find suitable roles in non-profit organizations. Similarly, non-profit organizations are unaware of such skilled volunteers, and their availability. Thus, there is a need to aid volunteers and non-profit organizations to engage with each other.

Non-profit organizations such as VolunteerMatch.org have bulletin boards that enable volunteers and non-profit organizations to match the skills possessed and required, respectively. The non-profit organizations post a requirement for a skill and the volunteers possessing the skill respond to the requirement and connect therewith through the VolunteerMatch.org webpage. However, none of these firms have a mechanism to incent the volunteers, or an engagement platform for collective endeavors across the social good eco-system that would make volunteerism grow and proliferate.

Further, non-profit organizations need to rely on principals and volunteers to conduct their operations and generate social good. Their operations do not provide monetary return to their principals. For example, a non-profit organization provides service to homeless and needy individuals and families by providing shelters thereto. Though, the non-profit organization incurs costs to provide these services, they do not generate profits out of their efforts. Thus, the non-profit organizations rely on principals to provide charitable funds, and count on unpaid volunteers to defray their cost of delivering services to the needy.

Further, the principals and volunteers make their contributions independently, and not collectively. Given the nature of the market for social good, it makes a lot of sense to offer support to social causes collectively. This would mean that donors collaborate and involve other institutions and individuals in giving time and money. For instance, the Bill and Melinda Gates Foundation could match the financial contributions of individuals to specific causes. The corporations like Cisco Systems could go one step further and solicit the employees to not only donate cash to support these causes, but also encourage them to volunteer with non-profits. However, less than 15% of employees have been motivated to do so. Similarly, many a time, non-profit organizations face difficulty in persuading people with desired skill sets to volunteer for their causes. It is an imperative to encourage and incent people who volunteer their time for social causes. The present invention presents a novel, and unique system to accomplish this.

In the commercial domain, a known technique to influence consumer behavior is the frequent flyer program (FFP) in the airline industry. The FFP is a loyalty program offered by airline companies that enables customers to earn and accumulate air miles by flying with the airline company. The consumers can then redeem the accumulated air miles for air travel, goods and services such as magazine and gift cards, or increased benefits such as upgrade in travel class, airport lounge access, and priority bookings. Thus, the air miles correspond to a type of virtual currency that can be exchanged for a specific set of perks. As described above, a customer is incented by an airline company for flying therewith to encourage the customer to fly more often with them. Further, the airline company does not limit the method of accumulating air miles only to flying but extends the method to include payments using credit or debit cards issued by their partner companies such as American Express. Thus, the airline companies encourage more number of people to fly with them and also increase the loyalty of their customer base. Air miles are a virtual currency in the commercial domain with certain features set by the air mile companies. The air miles earned by customers are meant for personal use, not to pay-it-forward for charitable causes. Thus, the FFP loyalty program is to incent consumers in a for-profit domain, and not designed to encourage volunteerism.

Canadian patent application serial number 2,354,419 by Herrenkohl et. al., discloses a participant incentive loyalty program based on alternative currency systems. It encourages participant loyalty in transactions, and includes an alternative-currency-issuing business, an alternative-currency-redeeming business, and a gateway system. The gateway system is adapted to read electronic transactions at participating businesses using payment mechanisms pre-selected by participants who wish to take advantage of the incentive system. This is a broad-based loyalty program based on a virtual currency earned through commercial transactions, and is not designed to promote volunteerism or charitable giving.

Alternative crypto-currencies, such as Bitcoin seek to create a virtual currency for global applications. They use some form of cryptography to enable the transactions to be made in a secure environment. Since the first implementation of Bitcoin, various cryptocurrencies have been developed that aim at implementing a distributed, decentralized and secure digital currency. The “programmable” aspect of the currency is being applied to other currencies to limit their production and preserve the value. As the virtual currencies rise in popularity, a few start-up companies have tried to piggyback on Bitcoin by creating specialized currencies linked to Bitcoin. For example, ProCoin invites charities to register with them, and subsequently relies on the growing number of Bitcoin-enthusiasts to donate to the cause in Bitcoins. To cash in on donations, charities need an exchange to convert ProCoin to Bitcoin. As such, it is implicit that this system of charitable giving is just a variant of BitCoin and its adoption is limited to the sub-set of the Bitcoin user base. This system is very restrictive with its focus on individual donors, and the co-dependence on an immature virtual currency reduces efficiency, increases risks and diminishes the credibility of ProCoin. This crypo-curency is not designed to promote volunteerism, or integrate philanthropy and volunteering.

US patent application serial number 2009/0089168 by Phyllis Adele Schneck discloses an alternative currency exchange (ACE). In this system, the alternative currencies are mapped on to the known real world currencies and an exchange rate therefore is maintained. In various embodiments of Schbeck, the alternative currencies in the form of airline miles or rewards, hotel rewards, credit card points, and cash generated from within virtual environments, such as online games, are supported. Further, PCT application serial number WO 2011/008630 by Mehew et. al., discloses an alternative currency value exchange system which creates user accounts at an alternative currency platform. A first user makes an alternative currency exchange offer. The alternative currency exchange offer includes one or more offer terms and associated assets. The alternative currency exchange offer is extended from the first user to the second user, in response to receiving acceptance of the offer from the second user. The associated assets of the first user and the second user are verified, and in response, settlement of the alternative currency exchange offer is made. However, such systems are meant for creating liquidity for commercially-oriented loyalty programs such as air miles, and not meant for use within the charitable giving environment where entities like non-profit organizations or non-government agencies benefit from the use of alternative currencies. The above patent applications seek to address economic and technological issues quite different from this patent application, and none of them propose a currency system and methods for integrating principals and agents of social good.

US 2014/0006135 by Joel Eben Vergun discloses a method of using an alternate currency system, also referred to as “social currency”, to promote charity in a commercial environment. The method includes establishing a reserve bank for the social currency, and soliciting non-profit organizations and businesses to utilize the social currency. An initial amount of currency is provided to the non-profit organizations and businesses. The businesses receive the initial amount of the currency based on a level of sponsorship that the respective businesses provide to the non-profit organizations. Further, the businesses are provided an opportunity of advertising on the currency. The non-profit organizations are encouraged to provide the social currency to individuals and businesses that donate economic currency thereto. The individuals are encouraged to use the social currency with businesses in return for goods and services.

However, the method disclosed resembles a commercially-driven loyalty program that is implemented in the social good domain. It is a commercially-driven value proposition to the marketing and sales department of businesses and not the CSR department. The patent application describes the alternate currency viz. DishFish Dollars as a form of social currency. In reality, the DishFish Dollars function as discount coupons that are provided by non-profits as thanks or incentives to donors who contribute money thereto. As mentioned above, the donors utilize the DishFish Dollars to purchase goods or services at businesses that accept the DishFish Dollars. Thus, the DishFish Dollars can be utilized only for personal use by the donors. More importantly, they do not have an option to transfer the DishFish Dollars to other individuals who can in turn transfer the same to other non-profits. This feature of personal use of the DishFish Dollars restricts the social good generated. Moreover, the method requires the establishment of a “reserve bank,” and in turn, a reserve capital to pay the DishFish Dollars to the non-profits and businesses. The method does not have any provisions for the businesses to contribute large sums of money and earn a tax exemption for corporate discounts. Further, there is no provision to incentivize volunteers based on their skill level. The patent application neither describes the criteria to calculate the amount of the DishFish Dollars that is to be provided to donors nor a provision to log and track the number hours contributed by a donor. Thus, the aforementioned method of utilizing social currency fails to multiply social good by motivating donors and non-profits.

Currently, there is no efficient, stable system for purposeful charitable giving that satisfies the corporations and philanthropists while providing incentives to volunteers and non-profits to increase their social impact. It is this inefficiency that the present invention seeks to address by offering a novel system and associated methods that facilitate transactions of charitable funds among key stakeholders of social good. The interactions among corporations, philanthropists, volunteers, and non-profit organizations multiply social good due to the network effects, and increased participation by the society.

### SUMMARY

In a stable ecosystem where the key players are more or less fixed and trusted, it is possible to introduce a more efficient system for managing charitable funds and volunteering, which can increase social impact, under several models of social good.

An object of the present invention is to provide a more efficient and reliable system for managing charitable funds in the ecosystem that includes corporations, philanthropists, volunteers and non-profits that seek to do social good.

Another object of the present invention is to provide a system wherein the corporations or philanthropists can increase the return on their spending on Corporate Social Responsibility and Social Good.

Yet another object of the present invention is to provide a system for an efficient transaction between the principals (philanthropists/corporations) and volunteers.

Yet another object of the present invention is to provide a system for an efficient transaction between the volunteers and non-profits.

Yet another object of the present invention is to provide a system for an efficient transaction between the non-profit organizations and the principals (philanthropists/corporations).

Yet another object of the present invention is to create a virtuous cycle of social good, driven by an increased visibility of actual social impact, amongst the key players in the system.

Yet another object of the present invention is to create an alternative currency unit that is programmable to have several characteristics of an exchange traded stock-option (call option with certain rights to the owner, but no obligations).

Embodiments of the invention provide a method for facilitating transactions of charitable funds and social currency units among principals and agents to increase social good. The principals include corporations and philanthropists, and the agents include volunteers and non-profit organizations. Finite units of a social currency are configured by the principal, and generated by a processor of a computer server. Each unit has a face value and a store of value associated therewith. The finite units of the social currency are stored in a memory coupled to the processor. A principal is enabled to sponsor, pledge, configure and guarantees the finite number of social currency units at the computer server. The finite number of social currency units is sponsored at a fraction of the face value associated with the finite number of social currency units. A volunteer is enabled to earn at least one social currency unit at the computer server. A non-profit organization is enabled to receive, store, redeem, pledge-back, or trade, the at least one social currency unit at the computer server. The volunteer contributes time and efforts at the non-profit organization to earn the at least one social currency unit. The time and efforts correspond to volunteer hours and a skill level of the volunteer, respectively. The volunteer hours and the skill level of the volunteer are validated at the computer server. At least one social currency unit is assigned to the volunteer based on the validation. The volunteer hours and the skill level are matched with the store of value of the social currency units at the computer server. The at least one social currency unit is transferred from the principal to the volunteer based on the assignment. Cashing of the at least one social currency unit by the volunteer for personal consumption is disallowed. The at least one social currency unit is gifted by the volunteer to the non-profit organization. The principal is facilitated to credit charitable funds to the non-profit organization in exchange of the at least one social currency unit at the computer server. The credited charitable funds are equivalent of the face value associated with the at least one social currency unit

Alternatively, the at least one alternative currency unit may also be transferred directly from the corporation or the philanthropist to a non-profit organization at the computer server. The units are backed not by the issuer, but the corporation or the philanthropist sponsoring it. The currency's value is supported by the volunteers and non-profits who voluntarily accept the units trusting the network of corporations and philanthropists that back the face value of these units. Once a critical mass of units is in place, the principals can choose to simply buy the currency already in circulation, providing liquidity to the currency.

The money could be “programmed” to come with multiple conditions: for instance, it might be released only if a third party certifies that the conditions are met, to be spent only by certain types of spenders, at specified locations, and so forth. Further, it cannot be used virtually anywhere—it can be used only within certain payment networks. For example, a corporation may match the charitable gift of an employee to a specific non-profit, after that non-profit certifies the receipt of the employee gift. Alternatively, a corporation may match the volunteering of an employee to a specific non-profit, after that non-profit certifies the hours of volunteering. For instance, Walmart Inc. may pledge to match the volunteering hours of its employees at Red Cross, to be donated to United Way, which may use it only at Sam's Club outlets using Walmart Money Card. Walmart can relax any of these conditions as the volunteers deliver on the social objectives it seeks to accomplish.

A philanthropic corporation may choose to relax the conditions and encourage its employees to do social good on a global scale by providing them with grants depending on their level of charitable contributions or volunteering, and give them the choice to gift it to non-profits of their choice. Corporations may want to promote volunteering in the broader communities they serve by tapping not only their employees but also the citizens. Foundations and philanthropists also may want to use these models to maximize the social impact of their spending on charity by choosing any of these modes.

The proposed method and the currency (hereinafter referred to as ‘Philas’) are different from the existing virtual currencies in six significant ways. Firstly, the domain of Philas is limited to the market for social good, to be earned by volunteers, and only to pay-it-forward, i.e., be gifted to accredited non-profits, (keeping it immune from commercially driven tractions as in the case of air miles or DishFish Dollars as described before). Secondly, Philas is to be sponsored, configured, issued, earned, gifted and spent by a set of known and trusted players, not anonymous parties as in the case of BitCoin. Thirdly, the currency is backed by the balance sheet or the bank accounts of the corporations and philanthropists (unlike BitCoin whose value is not guaranteed). For example, if Cisco Systems is issuing $10M worth of Philas, it is backed by Cisco's $40B balance sheet, just like its corporate bonds. Fourthly, the value of the currency is not based on scarcity (as with BitCoin 21M total units), and would be sponsored, configured, issued and spent depending on the growth of the market for social good; this also prevents volatility in the value of Philas due to manipulations by participants. Fifthly, the Philas can be tracked at every point. For example, it is possible to track who owns the Philas, when and where the Philas are transferred. Sixthly, corporations and non-profits have an option to sell the Philas as-is in the secondary markets. Thus, when a non-profit or a corporation possesses surplus Philas, it has an option to resell the same and earn cash.

The proposed invention is a significant improvement over the existing methods (see prior art in FIGS. 2 and 3), and it is significantly more valuable than its building blocks as the system seeks to serve a noble purpose for the society. Elements are eclectically chosen, which when combined offers significant value to two kinds of users—principals and agents of social good—and form a vibrant community for greater good. Thus the integration is novel, unique and useful. Technological environment and a specific implementation are also illustrated (FIG. 7, FIGS. 8a and 8b).

### BRIEF DESCRIPTION OF DRAWINGS

The features of the present invention—collectively termed Philas—are believed to be novel in its embodiment, and are set forth with particularity in the appended claims. Embodiments of the present invention will hereinafter be described in conjunction with the appended drawings provided to illustrate and not to limit the scope of the claims, wherein like designations denote like elements, and in which:

FIG. 1 illustrates the social good eco-system and interaction between various entities; viz., corporations, philanthropists, volunteers, non-profits and others (including society, consumers and regulatory bodies), that sets the dynamics of the present invention;

FIG. 2 is a flowchart illustrating a conventional method for facilitating transactions of corporate social responsibility (CSR) and Social Impact funds among corporations, their employees, and non-profit organizations dedicated to social causes, using fiat currencies, such as US dollars;

FIG. 3 is a flowchart illustrating a patent-pending method to use discount coupons as an alternate currency among individual donors, non-profit organizations and businesses supporting social causes;

FIGS. 4a and 4b are a flowchart illustrating a method for facilitating transactions of corporate social responsibility (CSR) funds or Foundation funds among corporations, philanthropists, volunteers, and non-profit organizations dedicated to social causes, using Philas, in accordance with an embodiment of the present invention;

FIG. 5 illustrates a matrix that shows various parameters that are used to configure or program the transactions between the principals and the volunteers in accordance with various embodiments of the present invention;

FIGS. 6a and 6b show another matrix that shows various parameters that are used to configure or program the transactions among the principals, volunteers, and non-profits in accordance with various embodiments of the present invention;

FIG. 7 is a block diagram illustrating a system for facilitating transactions of CSR and Social Impact funds among corporations, philanthropists, volunteers, and non-profit organizations dedicated to social causes, using Philas, alternative currency units, in accordance with various embodiments of the present invention;

FIG. 8a illustrates a schematic block diagram of an alternative embodiment of the system of the present invention; and

FIG. 8b illustrates a schematic block diagram of a central database of FIG. 8a in accordance with various embodiments of the present invention.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise.

There may be additional components described in the foregoing application that are not depicted on one of the described drawings. In the event such a component is described, but not depicted in a drawing, the absence of such a drawing should not be considered as an omission of such design from the specification.

The methods would include electronic on-line payment requests from a corporation or philanthropist, and debiting a principal account for an amount corresponding to the amount of the payment request, and debiting the account of the payee—a volunteer or non-profit.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

As Adam Smith explained in ‘Theory of Moral Sentiments,’ human nature is driven by social concerns as much as self-interests. Without social interactions driven by empathy, cities and economies cannot progress and grow. The proposed system and method encourages social exchanges amongst forward-looking citizens and communities. These citizens engage not only with the city officials but also the key stakeholders—corporations, non-profits and philanthropists. As cities develop and grow, the stakeholders collectively address a variety of issues that affect the sustainability and quality of city life. These include efficient delivery of emergency services, social services, telecom connectivity, transportation, utilities, physical safety, cyber security, education, and healthcare. Thus the social interactions enabled by real-time information exchange, provide access to resources that improve quality of life and spur economic growth.

Citizens as employees and consumers increasingly expect higher-order benefits from corporations. In response to this, corporations such as Unilever have repositioned themselves as social enterprises. Progressive philanthropists have emerged as significant forces in directing funds to social causes in the cities. Bill Gates and wife Melinda, together with Warren Buffett, envisioned the Giving Pledge—an effort to get America's wealthiest families to give away the majority of their wealth during their lifetimes. Since the trio launched the effort in June 2010, 127 billionaires have signed on.

At the same time, grassroots movements are proving every day how a single individual, regardless of wealth, can make a lasting impact on the lives of others. Peer-to-peer micro-lending is a good example of a new way of generating social good. Yet, within the social good space, the realms of philanthropy and volunteerism have stayed very siloed. The proposed system and method transforms this scenario by providing a new technology platform to integrate the social good pursuits of the principals (corporations & philanthropists), with those of the agent (volunteers and non-profits).

The system of the present invention is designed for the good of society—for multiplying the impact of philanthropy, and for use by a set of participants seeking to generate social good, not profits or personal income. It matches volunteer contributions with a novel currency unit which may be gifted to non-profits, who can redeem it for cash. As per various embodiments of the present invention, principals, configure, pledge contingent on contributions by the volunteers. The currency units earned are paid forward as charitable contributions for encashment by accredited non-profit organizations (for instance, those with 501 statuses). The system is programmable and restricted in use, in that the units can only be earned through volunteering and the earned units can only be gifted, not spent by the volunteers for personal consumption—for purchases or for availing services.

US corporations donate dollars to social causes whereas their American consumers contribute eight billion plus hours of volunteering. Social media technologies can integrate these two large related markets for social good. It is believed that charitable giving would grow by 10% annually as more billionaires become a part of the Giving Pledge, and Americans grow more wealthy and generous. America has 40 cities with a population of over half a million, which represents a social-media savvy segment with broadband and mobile connectivity (FCC Report 2014). They volunteer for about 120 hours a year (source: CNCS 2013 Report). The proposed method encourages corporations and philanthropists to contribute further in collaboration with the citizens. The proposed method also multiplies the contribution of principals by engaging the time and efforts of volunteers in various social programs. The system of the present invention addresses shifting corporate, consumer and employee preferences, and reduces existing market shortcomings. Further, the proposed method focuses on supporting the ongoing charitable giving of corporate sponsors and billionaire philanthropists, respectively.

The present invention provides companies with a user-friendly, engagement platform where their employees discover skill-aligned volunteer opportunities and can quantitatively measure social impact at the employee- and firm-level. Less than ten percent of corporate social good is carried out through social media, and the initiatives tread the beaten siloed path with poor network effects. Launching initiatives can be expensive and daunting and do not align well with large non-profits. The proposed engagement platform would enable companies to ‘Match, Measure, & Motivate’, and better implement corporate volunteer initiatives, enhance consumer-brand loyalty, employee satisfaction, and employee retention.

The underlying driver of the proposed invention is the novel currency units—Philas. The Philas will enable corporate sponsors to make pledges with conditions for volunteers to meet. Each volunteer will earn Philas for the hours contributed, based on the nationally established dollar value of volunteerism (currently $22.55). US Corporations spend about two billion dollars every year on cause-related marketing. While the social campaigns do provide much needed support to worthy causes, they are intended as much to increase company visibility and improve employee morale as to create social impact. A tobacco giant, for example, spent $100 million on its charitable contributions, and then launched a $100 million advertising campaign to publicize them. That's good business as 83% of the customers thought that they have a positive image of a Company that publicizes the social causes it supports. A handful of companies have begun to use context-focused philanthropy to achieve both social and economic gains. Cisco Systems, to take one example, has invested in an ambitious educational program—the Cisco Networking Academy—to train computer network administrators, thus alleviating a potential constraint on its growth while providing attractive job opportunities to high school graduates. By focusing on social needs that affect its corporate context and utilizing its unique attributes as a corporation to address them, Cisco has begun to demonstrate the unrealized potential of corporate philanthropy. Taking this new direction, however, requires fundamental changes in the way companies approach their contribution programs. Corporations need to rethink both where they focus their philanthropy and how they go about their giving. The proposed system and method offers to help corporations accomplish their dual-goals of social impact and cause-based marketing.

The volunteer can choose to gift Philas to a charitable organization, thereby unlocking the funds pledged by the corporations. The increased impact through this novel system incentivizes the volunteers to give more time; the gamification and the collective efforts make it more engaging to do social good, and supplement with contributions in cash. The ability to direct funds purposefully may attract corporations to commit even more dollars to causes they care about. Thus the proposed system not only increases the efficiency of the market for social good, but also expands the market.

It should be noted that the system and currency of the present invention are interchangeably referred to as Philas, social currency, alternative currency, social good currency, and social good currency with conditions throughout this disclosure, without departing from the scope and spirit of the present invention. The Philas are units of alternative currency that are generated by the system of the present invention by using one or more embodiments of the present invention, and exhibit one or more characteristics as described in the forthcoming description.

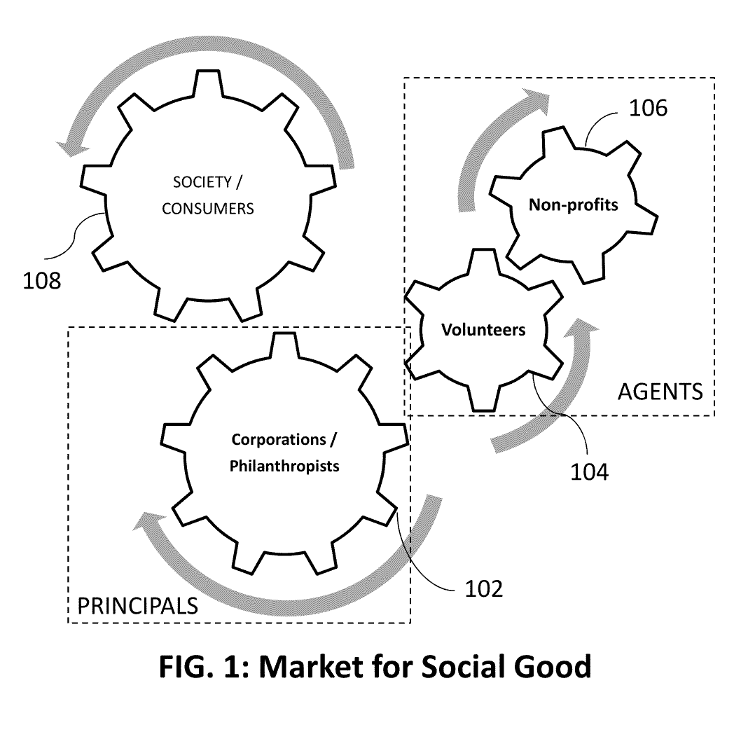

FIG. 1 illustrates interaction between various entities viz., the principals 102 such as corporations/philanthropists and agents such as volunteers 104 and non-profit organizations 106, in one complete transaction cycle of Philas, in accordance with an embodiment of the present invention. FIG. 1 further includes an entity viz. society/consumers 108 that includes government regulatory authorities, consumers, and service providers. The government regulatory authorities function along with the principals 102 to provide a wider impact of various programs taken up by the principals 102. Further, the consumers contribute to the social good domain by purchasing products/services from the corporations that have positioned themselves as social enterprises. As cited above, Unilever has positioned itself as a social enterprise and thereby, has increased its sales.

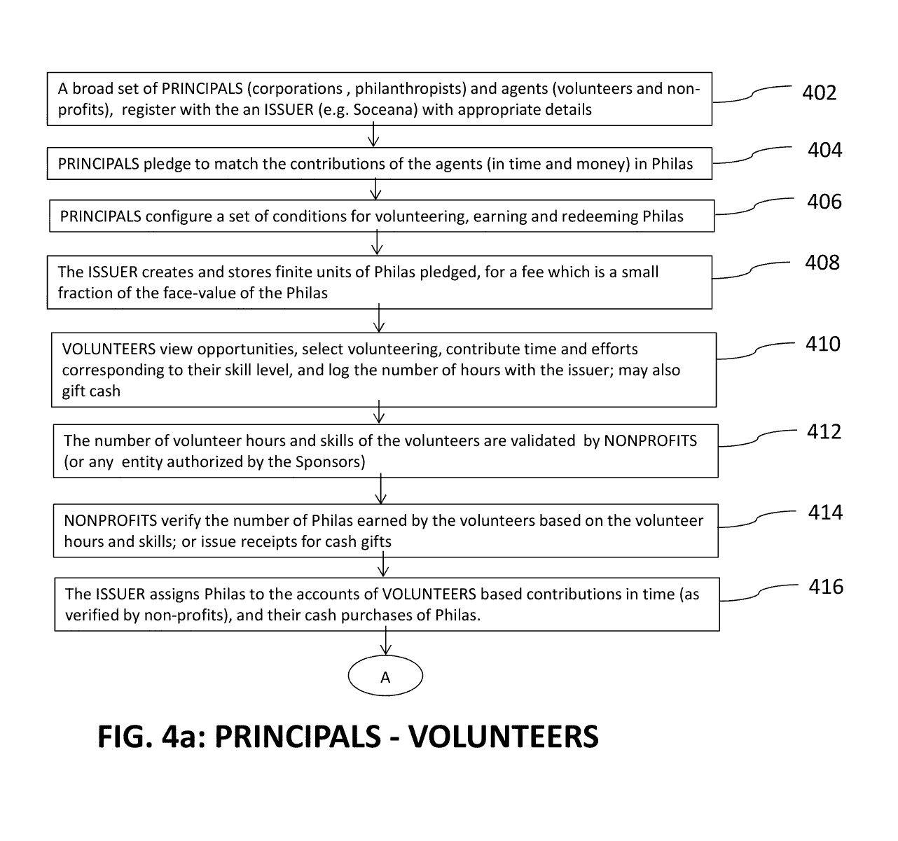

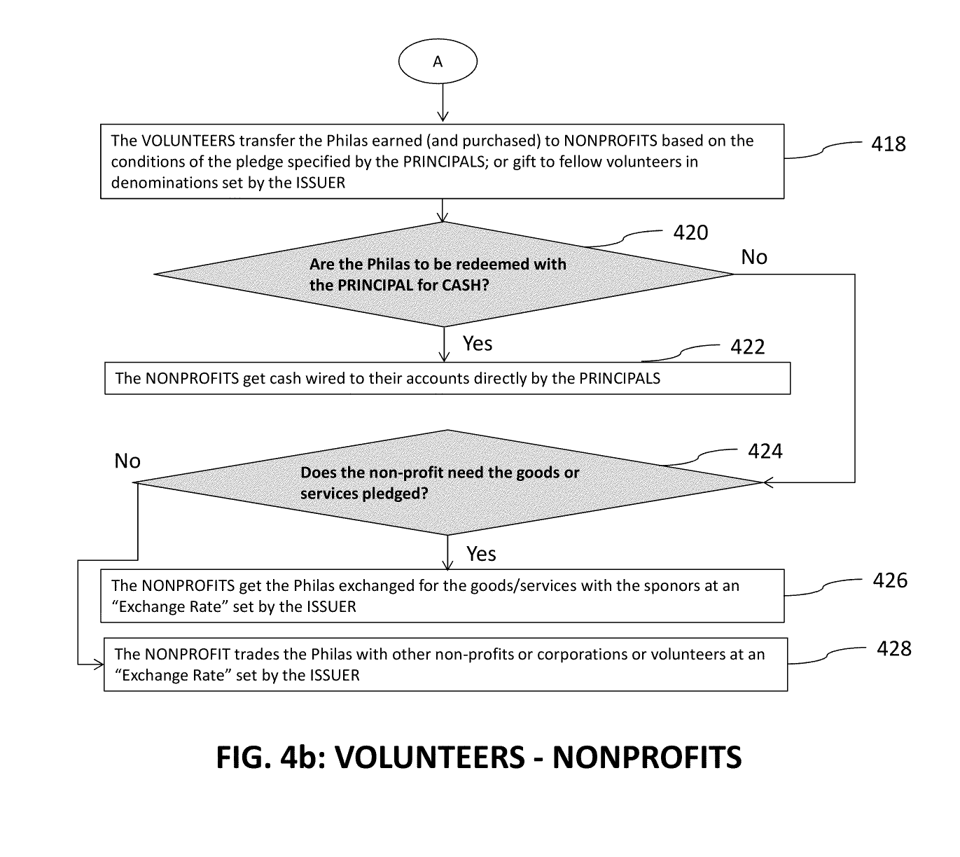

Principals such as corporations or philanthropists 102 are the primary drivers in the system. They trigger the transaction cycle by buying units of Philas from an issuer (e.g., Soceana), such as the system of the present invention (described in detail in conjunction with FIGS. 4a, 4b, 5, 6a, and 6b). These alternative currency units are in turn used to incentivize a volunteer 104, who can convert her volunteer hours into Philas. The volunteer 104 has the option to gift the accrued Philas to other volunteers who can store or spend it as they choose. Volunteers 104 can also donate Philas to a non-profit organization 106 which can encash it to a fiat currency and use the funds to further increase volunteering and on social causes that the organization 106 is working towards. The non-profit organization 106 may choose not to encash the Philas and instead transfer the Philas to volunteers 104 to increase volunteering or transfer the Philas to another non-profit organization 106. Once a critical mass of units are in place, the principals 102 can choose to simply buy the currency already in circulation, providing liquidity to the currency.

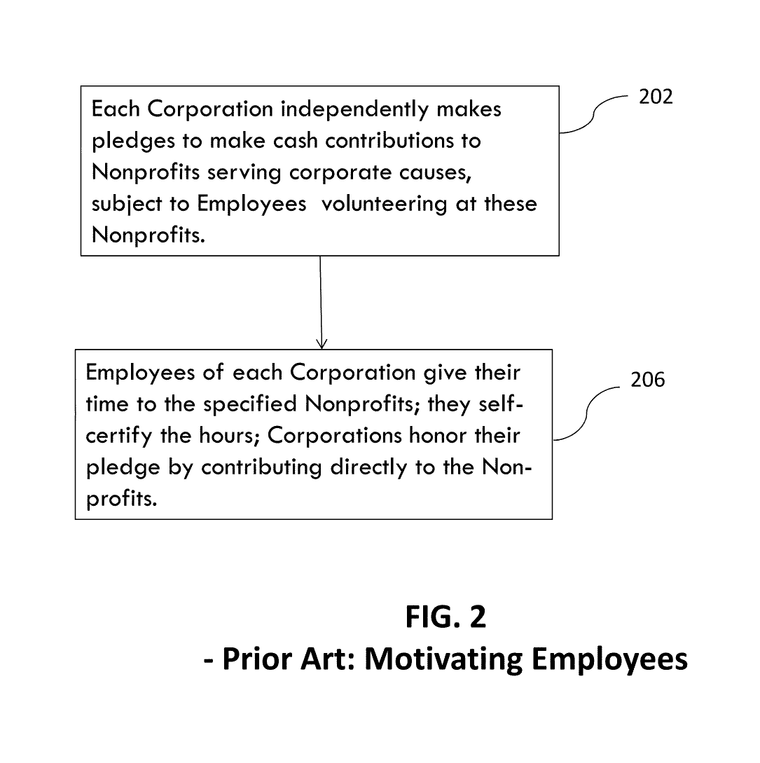

FIG. 2 is a flowchart illustrating a method for facilitating transactions of CSR and Social Impact funds among corporations, employees, and non-profit organizations dedicated to social causes, using fiat currencies (e.g. dollars). This is a simplistic method which has several limitations including little flexibility for corporations or its employees to meet their unidentical philanthropic goals. The employees have little flexibility to choose causes, type of work or non-profits to contribute to; the corporate contributions are restrictive and specific. The corporations have little flexibility to include non-employees and new non-profits, measure impact and create an inclusive model for corporate philanthropy and volunteering. It leaves out important stakeholders, such as non-employee volunteers, similar-minded corporations, and philanthropists. This severely limits the social good generated from the corporate contributions.

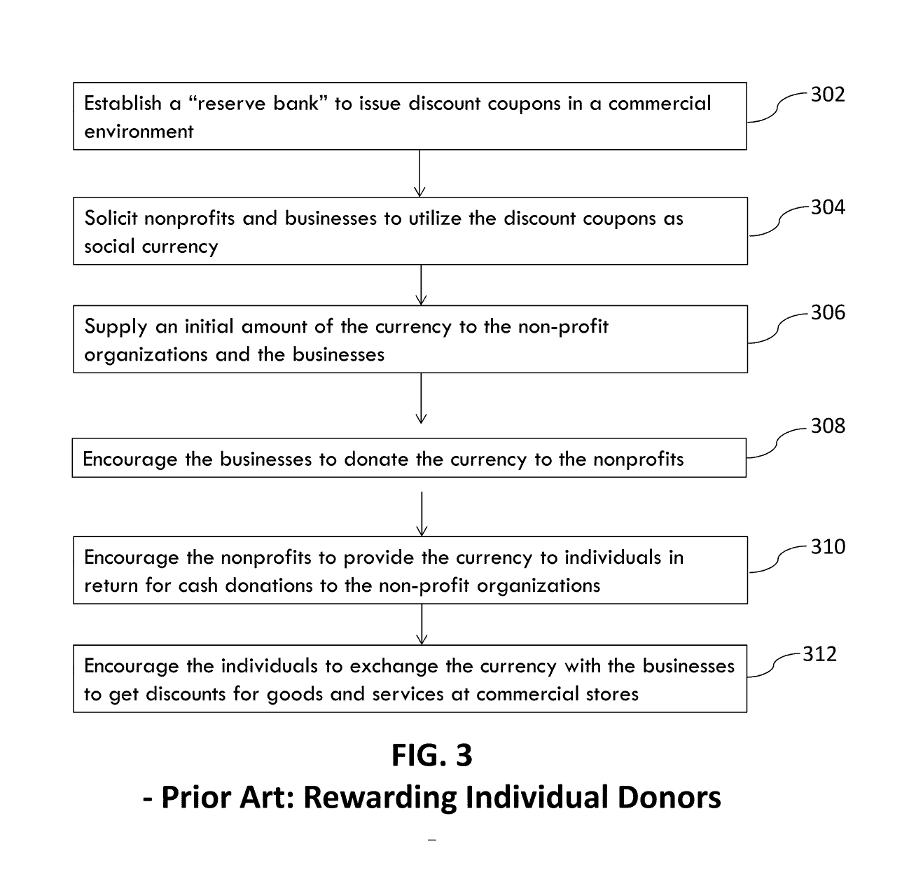

FIG. 3 is a flowchart illustrating a method for facilitating transactions of social currency in a commercial environment among individual donors, businesses, and non-profit organizations. As explained earlier, the method is predicated on establishing a reserve bank for the social currency, and soliciting non-profit organizations and businesses to utilize the social currency to give discounts at retail outlets. An initial amount of currency is provided to the non-profit organizations and businesses. The businesses receive the initial amount of the currency based on a level of sponsorship that the respective businesses provide to the non-profit organizations. Further, the businesses are provided an opportunity of advertising on the currency. The non-profit organizations reward their individual donors with the social currency to individuals. The individuals are encouraged to use the social currency with businesses in return for goods and services.

However, as described earlier, the method disclosed has several drawbacks such as the requirement to create a reserve capital, and the absence of a logging and tracking provision to log the number of hours contributed by individual donors and to track the DishFish Dollars in real-time. Further, the method of using the DishFish Dollars resembles a commercially-driven loyalty program that has been attempted in the social good domain. The primary objective of the method is to enable non-profits to reward their donors with discount coupons instead of memorabilia. The feature of personal use of the DishFish Dollars is inconsistent with the idea of philanthropy and volunteerism. According to Giving USA Foundation, donors are driven by generosity, empathy, responsibility, and social recognition and not by commercial gifts (or quid pro quo). Thus, the aforementioned method of utilizing social currency fails to increase social good by motivating corporations, philanthropists and individual donors.

FIGS. 4a and 4b are a flowchart illustrating a novel method of transaction of charitable funds and social currencies among principals and agents to increase social good, using Philas, in accordance with an embodiment of the present invention.

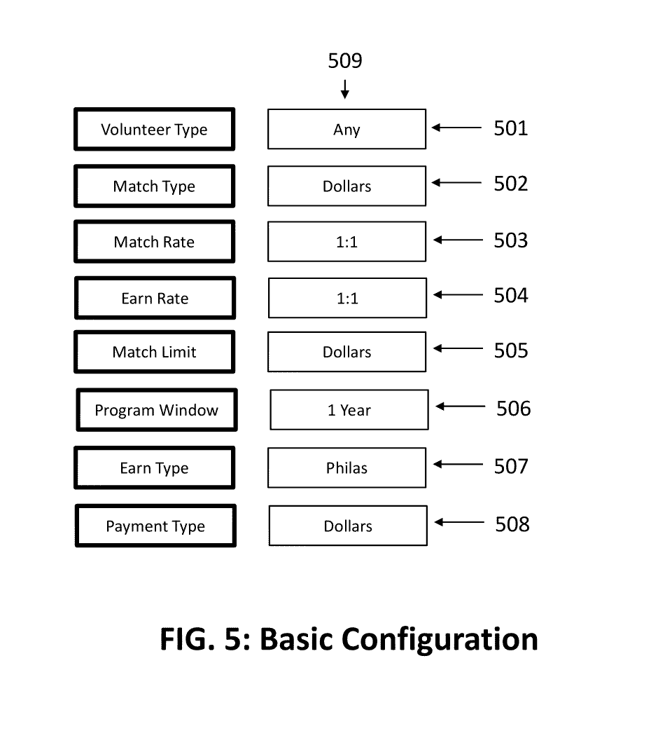

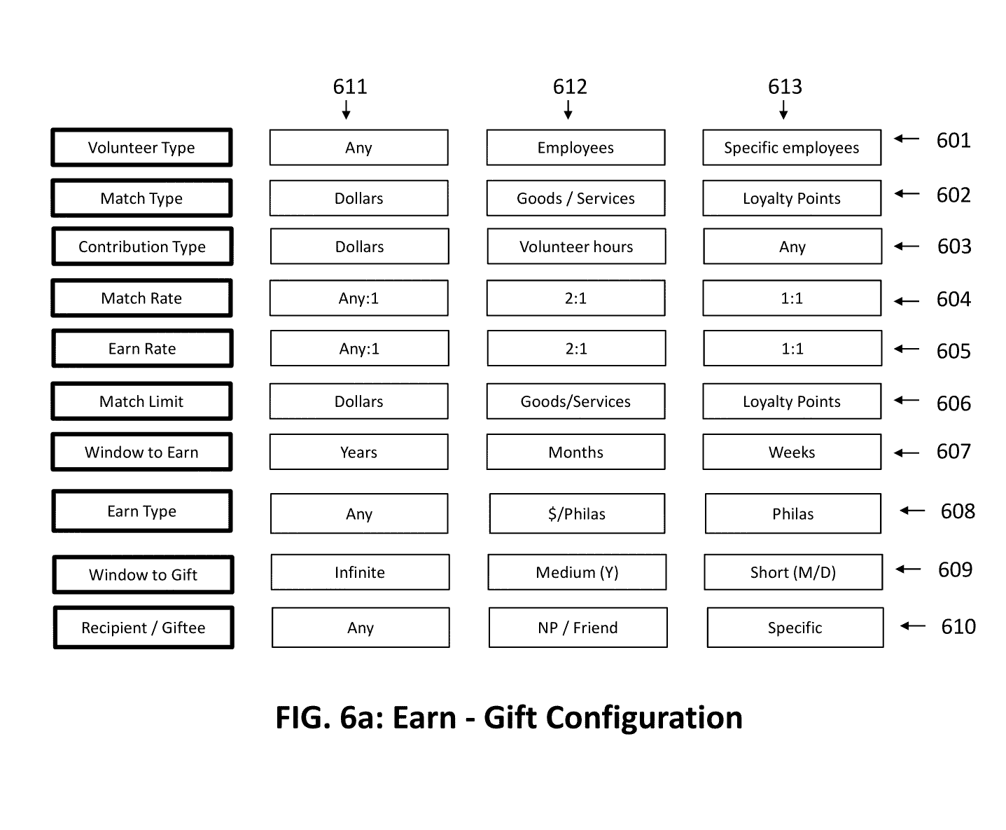

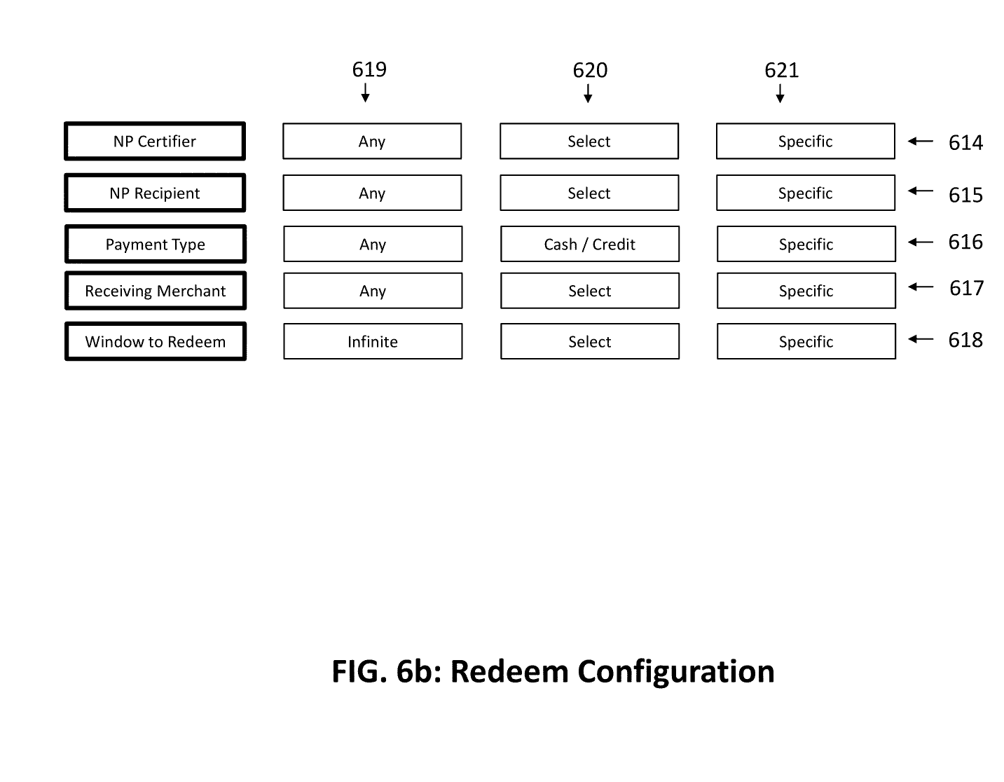

In an embodiment of the present invention, at step 402, corporations, philanthropists, volunteers and non-profits register with an issuer (e.g. Soceana) with appropriate details. At step 404, principals pledge to match the contribution of volunteers in Philas. The contribution of the volunteers may be in terms of time and/or money. At step 406, principals configure a set of conditions for volunteering, earning, and redeeming the Philas. The set of conditions is defined by certain parameters explained in the FIGS. 5, 6a, and 6b. At step 408, the issuer creates and stores finite units of the Philas pledged, for a minimal fee of a fraction of the face value of the Philas. At step 410, volunteers view the available volunteering opportunities such as earning of Philas in exchange of volunteer hours and/or cash. The volunteers select a preferred non-profit organization to serve based on their skill sets, volunteer at the non-profit organization, and log the number of volunteer hours and skills with the issuer. At step 412, a verifying authority such as a non-profit organization validates the volunteer hours and the skill set of the volunteers. At step 414, the non-profit organizations verify the number of Philas earned by the volunteers based on the validated volunteer hours, the skill set, and the cash gift. At step 416, the issuer assigns the Philas to the accounts of the volunteers based on the validation. The number of Philas credited to the volunteers is determined by a predetermined conversion rate. This may be supplemented by the cash purchases of Philas by the volunteers at Exchange Rates set by the issuer. The volunteers use the earned (as well as purchased) Philas as a store of value and medium of exchange. The volunteers can re-gift the earned Philas to other volunteers in any denomination or form; however the primary purpose is to gift it to accredited non-profit organizations in the network. At step 418, the volunteers view opportunities to transfer the Philas back to the same non-profit organization or an alternate non-profit organization of their choice based on the predefined conditions set by the corporation or philanthropist. On selecting the recipient, the volunteers allocate the earned Philas thereto. Instead they may opt to gift it to fellow volunteers (friends) in denominations set by the issuer. At step 420, the non-profit organizations that receive the Philas determine whether the Philas can be redeemed for cash at the corporation or philanthropist. If, at step 420, it is determined that the Philas are to be encashed, step 422 is performed by the non-profit organizations. At step 422, the non-profit organizations get the Philas encashed at the corporation or philanthropist. The credited charitable funds are equivalent of the face value associated with the Philas. If, at step 420, it is determined that the Philas are not to be encashed, step 424 is performed by the non-profit organizations. At step 424, the non-profit organizations determine whether they need the service/goods associated with the Philas. If, at step 424, it is determined that the non-profit organizations need the service/goods, step 426 is performed by the non-profit organizations through the Issuer. At step 426, the non-profit organizations get the Philas exchanged for the service/goods with the principal, at an Exchange Rate set by the Issuer. This exchange rate is dependent on the distinguishing characteristics of the social currency described in FIGS. 5 and 6. These include, principal, volunteer type; a match type; contribution type; a match rate; an earn rate; a match limit; a window to earn; earn type; a window to gift; a recipient; a certifier; a nonprofit recipient; a payment type; a participating merchant; a window to redeem; and a combination of two or more thereof.

If, at step 424, it is determined that the non-profit organizations do not need the service/goods, step 428 is performed by the non-profit organizations. At step 428, the non-profit organizations trade the earned Philas with other non-profit organizations or volunteers or corporations. Subsequently, the issuer draws an amount equivalent to the face value of the Philas underwritten by the original principals (philanthropists/corporations), logs all accounts in the system and issues certificates. Further, each Philas has a unique corresponding identification (ID) associated therewith that facilitates the process of tracking each Philas.

The Philas serve as an incentive for the volunteers to generate social good and help the principals leverage the CSR ecosystem. Every dollar the corporation spends motivates somebody to volunteer and then re-gift it to a non-profit organization, which would in turn use the money and Philas to increase volunteering, hence creating a cycle of social good. The most important merit of this system is that the principals do not have to pay the face value of their pledge upfront, hence creating manifold return over the course of an entire cycle.

For example, a pledge for Philas of face value $100, sponsored by paying $5 (a fraction of the face value), generates a 20-fold return in terms of social good generated by the first volunteer even before the $100 gets donated to the non-profit organization, which then sets off another virtuous cycle of social good. Hence, the spending has a “force-multiplier effect” and generates higher returns on charitable spending by corporations and philanthropists. The utility of such a system to all participants is apparent.

In an embodiment of the present invention, the volunteers can keep the Philas as a store of value, view it, and donate it to non-profits, ensuring correct channelling of the charitable funds while meeting the self-esteem and self-actualization needs of themselves.

The principals may cause to issue more and restrictive Philas to meet their specific philanthropic goals, however, they serve as a lasting symbol of value to the volunteers, of the social good generated by volunteering. Once programmed and issued, the alternative currency can take the form of a cryptocurrency or in traditional forms such as gift cards, points, coupons, air-miles or certificates.

FIG. 5 shows a matrix that shows various parameters, using which the Philas at the pledge are programmed or configured by principals or issuers, to facilitate a transaction between the principals and the agents of social good in accordance with various embodiments of the present invention. These parameters once set by the principal (e.g. Cisco Systems) or the issuer (e.g. Soceana), serve as the distinguishing characteristics of each tranche of social currency units. The Principals of the currency may be corporations, such as Cisco or Walmart; foundations, such as Bill & Melinda Gates Foundation, the Dell Foundation, etc.; and individuals, such as high net-worth individuals (HNIs). As can be seen from FIG. 5, there are eight rows (from row 501 through row 508) and a single column (column 509), in which the various parameters for programming the system are listed. For configuring the system of the present invention, eight parameters (or variables) need to be selected; and for each such parameter, there exists a number of possibilities or options (509). In the forthcoming description, the entire process for configuring the system of the present invention by selecting these parameters has been explained. It should be noted that while only a few possibilities are illustrated in detail, any other combinations are well within the scope of the present invention.

The row 501 lists the ‘volunteer types’. In an embodiment of the present invention, any individual or employees of an organization may be enabled to participate in the volunteering process. The participating organization (principal) has complete control over defining this parameter. For example, a corporation such as Walmart may declare that any of its employees may volunteer and the volunteered hours will be matched by Walmart for social good. Similarly, the row 502 lists the ‘match type’ that a corporation may choose to match. In an embodiment, dollars can be matched for only dollars. In other embodiments the match may be in other non-cash forms. This includes goods, services, and virtual objects that have economic value. For example, HP may match 100 computers worth $1,000 each for an aggregate value of $100,000. H&R Block may offer 1000 hours of tax preparation services worth the same aggregate value. American Airlines may choose to match the same aggregate value with one million AA Advantage Miles.

The row 503 lists the ‘match rate’ that can be specified by the principals. A principal decides the match rate based on the requirement of a non-profit organization. In an embodiment, a match rate of 1:1 is enabled. In the above example, Walmart may specify that for every volunteer hour by the specified volunteers, 1 dollar will be matched (1:1 scenario).

The row 504 lists the ‘earn rate’ that can be specified by the principals. An earn rate is determined based on the skill level of the volunteer. In an embodiment of the present invention, the earn rate is defined as 1:1.

The row 505 lists the parameter ‘match limit’. The match limit specifies the upper cap on the ‘match type’ parameter. For example, Walmart, when it chooses to match dollars, may specify that it will have a match limit of one million dollars. In other words, the match type is capped at one million dollars.

The row 506 lists the parameter ‘program window’. The program window specifies the time for which the program initiated and sponsored by the principals remains valid. For example, a corporation organizes a six-month financial-literacy training drive in various cities. Thus, the program has a program window of six months, during which volunteers can sign up and support the drive with time and money.

The row 507 lists the ‘earn type’. The earn type specifies the type of currency/commodity volunteers may earn. In an embodiment, the volunteers may earn Philas in return for the donated cash and/or efforts.

The row 508 lists the various options for ‘payment types’. The system of the present invention supports a number of payment methods. This payment type refers to the mode using which the non-profits that receive the money spend that money. For example, a debit card or gift card like instrument may be issued which is preloaded with the dollars matched by the corporation. Or an electronic wallet may use which can be loaded periodically. Alternatively, the money may go into the bank account of the non-profit or have a list of options like payment gateways/providers to choose from. In yet another alternative payment type, the non-profit may receive a service (e.g. computers, smart phones or air conditioners) in exchange of the Philas.

FIGS. 6a and 6b show an advanced matrix that shows various parameters which are used to configure or program the transactions among the principals, volunteers, and non-profits, using which the Philas are programmed or configured when the principals pledge the Philas in accordance with various embodiments of the present invention. These parameters once set by the Principal and approved by the Issuer, serve as the distinguishing characteristics of each tranche of social currency units. Referring now to FIG. 6a, the parameters that define a set of conditions for the volunteers are illustrated. As can be seen from FIG. 6a, there are ten rows (from row 601 through row 610) and three columns (from column 611 through column 613), in which the various parameters for programming the system are listed. For configuring the system of the present invention, ten parameters (or variables) need to be selected; and for each such parameter, there exists a number of possibilities or options columns (611, 612, 613). In the forthcoming description, the entire process for configuring the system of the present invention by selecting these parameters has been explained. It should be noted that while only a few possibilities are illustrated in detail, any other combinations are well within the scope of the present invention.

The row 601 lists the different ‘volunteer types’. In various embodiments of the present invention, any person that belongs to an organization, or select employees of the organization, or specific employees that meet certain criteria may be enabled to participate in the volunteering process. The participating organization (principal) has a complete control over defining this parameter. For example, a corporation such as Walmart may declare that any of its employees may volunteer and the volunteered hours will be matched by Walmart for social good. Walmart may also select employees that meet certain criteria (employee's age, number of years of employment, and so forth) for matching their volunteer hours. Similarly, the row 602 lists various ‘match types’ that a corporation may choose to match. In one embodiment, dollars can be matched for only dollars. In other embodiments, dollars can be matched for volunteer hours, goods, or services. The participating principal can select one of these options while configuring the parameter.

The row 603 lists the different possible ‘contribution types’. Volunteers may contribute volunteer hours by working for a social cause at a non-profit, and earn the currency units. Alternatively, some principals may encourage volunteers to contribute in dollars, or goods by matching their contributions. The volunteer may choose to make charitable cash contributions to the nonprofits; if the match rate is 1:1, he would earn 100 currency units (Philas) for $100 contribution. In another embodiment, a volunteer may contribute old functioning laptops or unused air miles to a non-profit organization. The volunteers earn Philas in exchange of dollars or goods or volunteer hours. In an embodiment the issuer would set the value for frequently gifted goods or services, at a discount to their market prices.

The row 604 lists the different possible ‘match rates’ that can be specified by the principals. A principal decides the match rate based on the requirement of a non-profit organization. In an embodiment, any match rate is possible, i.e., every available volunteer hour can be matched by any number of dollars. Various other embodiments enable 2:1, 1:1 or similar match rates. In the above example, Walmart may specify that for every volunteer hour by the specified volunteers, 2 dollars will be matched (2:1 scenario). In another example, a volunteer is required to provide her service at a remote location. Walmart then decides a high match rate such as 3:1 to reward the volunteer who is ready to serve at the remote location. In this case, the match rate is dependent on the location. In yet another example, the match rate is determined based on the type of volunteer involved in the volunteering process. Walmart may choose to increase its match-rate for its employees to provide super-incentives to them to volunteer for charitable causes. An employee of Walmart that pledges the Philas is assigned a match rate of 4:1 whereas any other volunteer is assigned a match rate of 1:1. In this case, Walmart has generated significant social good, by directing the efforts of its 2M+ employee base toward charitable causes; this is over and above the social impact from Walmart's cash contributions to the non-profits.

The row 605 lists the different possible ‘earn rates’ that can be specified by the principals. As mentioned in the foregoing, an earn rate is determined based on the skill level of the volunteer. For example, a volunteer who is a college professor in mathematics volunteers to teach high school students, and rates himself at twice (2×) the base rate. This would mean that he would earn 50 Philas per hour instead of 25 Philas earned by a mathematics teacher whose skill levels are lower, and hence the opportunity costs are lower. This higher rate is then validated and certified by the non-profit the mathematics professor volunteers at.

The earn rate works in combination with the match rate. For example, a non-profit organization needs qualified mathematics teachers but neither the teachers are ready to teach at a minimal tuition fee nor the non-profit organization can afford the high tuition fees quoted by the teachers. In this scenario, the corporation assigns a high earn rate such as 4:1 to a teaching service. Thus, the corporation assigns the earn rate based on the skills of the volunteers. Considering a face value of 1 Philas equal to 1 dollar, and that a 1:1 match rate is defined as 25 Philas per hour, a teacher teaching at the non-profit organization earns $100 per hour based on the match rate of 4:1.

Further, the earn rate is determined based on the feedback received from the non-profit organization regarding the volunteer. For example, in the aforementioned example, if the mathematics professor fails to teach the high school students successfully, the non-profit organization provides a negative feedback to the issuer. Subsequently, when the mathematics professor wishes to volunteer at another high school, the earlier received negative feedback affects his earn rate and may be reduced to 3:1. Over time, the earn rate may also be determined based on the value of contributions to non-profit organizations. Thus, in an example, a volunteer who donates $1,000 in cash as well as 10 hours may be assigned a higher earn rate in comparison to a volunteer who only gives the 10 hours. The earn rate is also a function of the frequency of volunteering and contributing by a volunteer. A volunteer who has a higher frequency of either volunteering or donating cash is assigned a higher earn rate.

The row 606 lists the various possible scenarios for the parameter ‘match limit’. Match limit specifies the upper cap on the ‘match type’ parameter. For example, Walmart, when it chooses to match dollars, may specify that it will have a match limit of one million dollars. In other words, the match type is capped at one million dollars. Similarly, volunteer hours, goods, or services can also be capped by specifying the match limit. For example, a corporation may specify that it will donate a total of 1000 computers; in this case the match type ‘goods’ is capped at 1000 goods.

The row 607 lists the various options for the ‘window to earn’ parameter. This parameter specifies the time for which a program/volunteering service is available i.e. within the time limit specified by the ‘window to earn’ parameter, the volunteer can volunteer at a non-profit and earn Philas corresponding to the volunteer hours. In various embodiments, the window to earn duration may be infinite, in years, in months, in days, and so forth.

The row 608 lists the various options for the ‘earn type’ parameter. The earn type specifies the type of currency/commodity volunteers may earn. In this embodiment, the volunteers may only earn Philas in return of the donated cash and/or efforts, which cannot be used for personal consumption, only to pay-it-forward. In another embodiment, the volunteers may earn dollars or goods.

The row 609 lists the various options for the ‘window to gift’ parameter. This parameter specifies the time for which the currency will be valid from the time the volunteer earns the dollars/volunteer hours/goods/services. In various embodiments, the window to gift duration may be infinite, in years, in months, in days, and so forth.

The row 610 lists the various options for ‘recipient/giftee’. As stated earlier, the volunteer may utilize the Philas only to pay-it-forward, and not for her personal use. The volunteer may choose to gift the earned Philas to any non-profit, fellow-volunteer or friend. Like other parameters, any option may be selected by the principal. Columns 611, 612, 613 represent the number of possibilities or options in columns, as explained above.

FIG. 6b shows yet another advanced matrix that shows various parameters, using which the Philas are programmed or configured when the principals pledge the Philas in accordance with various embodiments of the present invention. The parameters here set the conditions for the non-profit organizations. As can be seen from FIG. 6b, there are five rows (from row 614 through row 618) and three columns (from column 619 through column 621), in which the various parameters for programming the system are listed. For configuring the system of the present invention, five parameters (or variables) need to be selected; and for each such parameter, there exist a number of possibilities or options.

The row 614 lists the various options for ‘non-profit certifier’. The hours clocked by the volunteers and the skills possessed thereby can be certified for authenticity by a non-profit certifying authority. A corporation may choose to enable ‘self-certified’ volunteer hours and skills (‘any certifier’) or make it mandatory that the hours be certified by a non-profit certifier, such as Red Cross or any certifier from an approved list of certifiers. It may also choose to get the certification done from a specific certifier, such as United Way or World Health Organization (WHO), or delegate this to the issuer of Philas.

The row 615 lists the various options for ‘non-profit recipient’. Once the volunteer earns the hours, the matching dollars may be received by one of these recipients. The principal may choose any non-profit to receive the money (note that the volunteers are not enabled to encash the volunteer hours in form of dollars, goods, or services). Alternatively, a recipient from a list of approved recipients, or a specific non-profit, may be designated as the recipient. Further, non-profits from a particular geography (for example, Africa or South America) or a specific sector (for example, healthcare or education) may be selected.

The row 616 lists the various options for ‘payment types’. As described earlier, the system of the present invention supports a number of payment methods. This payment type refers to the mode using which the non-profits that receive the money are going to spend that money. For example, a debit card or gift card like instrument may be issued which is preloaded with the dollars matched by the corporation. Or an electric wallet may use which can be loaded periodically. Alternatively, the money may go into the bank account of the non-profit or have a list of options like payment gateways/providers to choose from. In yet another alternative payment type, the non-profit may receive a service (e.g. computers or routers) in exchange of the Philas.

The row 617 lists the ‘receiving merchant’ or ‘vendor’ where the non-profit organization can spend the money. Like other parameters, any option may be selected. The receiving merchant may be any merchant, a list of approved/specified merchants, or a specific merchant chosen by the principal.

The row 618 lists the various options for ‘window to redeem’ within which a non-profit organization can spend the money they receive. Options include infinite (any time, and forever), select (for a limited amount of time and may be for a particular day of the week, time of the day, and so forth), or on specific days, etc. Columns 619, 620, 621 represent the number of possibilities or options in columns, as explained above.

Once all the parameters are specified by the principal, i.e., when the system is programmed by specifying the required inputs, a currency is created which reflects the specified parameters under one of the three columns (619, 620, 621). The selected parameters come into the eco-system of volunteers, principals and non-profit organizations. The system of the present invention supports multiple such customized eco-systems that encompass different principals, non-profits, and reward methods by keeping the central idea of charitable transactions common. The parameters such as ‘window to earn’, ‘window to donate’, ‘window to redeem’, and ‘gift’ ensure that the pledges are fulfilled in a stipulated time. This enables an integration of non-profit and volunteering through the alternative currency. These new methods to pledge, sponsor, issue, configure, earn, store, gift or spend the alternative currency strengthen the linkages among the key stakeholders—corporations, philanthropists, volunteers, and non-profit organizations.

Moreover, in some optional embodiments of the present invention, when no parameter values are specified, the system may intelligently choose the best suitable parameters for the scenario and program itself. This may be done by specifying the objectives, and the parameters based on the types of principals, their revenues and budgets, available non-profits, type of volunteer hours and so forth. A person skilled in the art would understand that some of the parameters may be made optional or various other parameters and entities can be added without departing from scope and spirit of the present invention.

In a stable ecosystem where the key players are more or less fixed, and trusted, this efficient system may be introduced for managing charitable funds, which can create social impact, under several models of charitable giving. The system of this invention is designed for the good of society—for multiplying the impact of philanthropy, and for use by a set of participants seeking to generate social good, not profits or personal income. It matches credits for volunteering, and not for payments for services. As per various embodiments of the present invention, principals pledge, and the system is contingent on performance by the volunteers. The matched volunteer hours can be paid forward as charitable contributions for encashment by accredited non-profit organizations. The system is programmable and restricted in use, in that the generated money cannot be spent by the volunteers for purchases or for availing any services. Further, unlike other currencies it may not be used virtually anywhere—it can be used only within certain payment networks.

The proposed system enables the money to be “programmed” to come with conditions: for instance, it might be released only if a third party certifies that the conditions are met, to be spent only by certain types of spenders, at specified locations. For example, a corporation may match the charitable gift of an employee to a specific non-profit, after that non-profit certifies the receipt of the employee gift. Alternatively, a corporation may match the volunteering of an employee to a specific non-profit, after that non-profit certifies the hours of volunteering. For instance, Walmart Inc. may pledge to match the volunteering hours of its employees at Red Cross, to be donated to United Way, which may use it only at Sam's Club outlets using Walmart Money Card. Walmart can relax any of these stipulations along the way as volunteers deliver on the social objectives it seeks to accomplish. As Philas is a type of virtual currency, principals do not have to spend money at the instance they pledge charitable funds but only when the conditions associated with the pledged Philas are fulfilled.

The dollar value of the Philas is derived based on various factors such as the total number of volunteers, the total number of volunteer hours spent collectively, the minimum wages, and the like. As the Philas are programmed with conditions, the face value of the Philas is also determined thereby. The number of Philas in the market is infinite. Each Philas is different from the other as the conditions associated therewith are different. However, the face value of the Philas is maintained constant for all the stakeholders. The value of the Philas is a direct function of supply and demand.

Corporations are enabled to exchange Philas with other corporations in order to create a market for the Philas. For example, a corporation may sell off its Philas worth $100,000 to another corporation if, due to a change in the company CSR policy during the course of the pledge, the corporation does not wish to contribute $100,000. This exchange of Philas between the two corporations may be at a discounted rate of Philas. The set of conditions associated with the Philas determines a sale value of the Philas. The more stringent or more number of conditions associated with the Philas, lower is the sale value of the Philas. Further, the validity of the Philas determines the sale value of the Philas. The longer the validity of the Philas, the higher is the sale value of the Philas. It is desirable that a corporation associates few conditions with the pledged Philas so that the sale value of the Philas does not decrease during the course of the pledge.

In an alternate embodiment of the present invention, a corporation may purchase Philas from a non-profit organization to circulate the Philas in the market. The non-profit organization may wish to sell its additional earned Philas to the corporation or other non-profit organizations. In an example, the non-profit organization receives Philas that can be used only to purchase computers. In such a scenario, the non-profit organization may sell the Philas to another non-profit organization that wishes to purchase computers. The non-profit organization that wishes to purchase computers buys the Philas at a discounted rate and hence, both the non-profit organizations are in a win-win situation. As mentioned in the foregoing description, a resale value of the Philas is determined by the associated set of conditions and the validity of the Philas.

Non-profit organizations spend 10% of funds raised on fund-raising fees and 15% for administration, overhead, and full-time employees. However, these expenses are significantly reduced by the use of Philas, by bringing in both donations and volunteers. Further, the use of Philas improves transparency of the transaction of the funds. The non-profit organizations use Philas to attract and promote volunteerism on a large scale. Many employees of the corporations that have made specific pledges with the issuer, volunteer at the specified non-profit organization to earn Philas so that they can donate those to a non-profit organization of their choice.

Moreover corporations do not spend real money unless the criteria are met. The criteria include a volunteer who works for the non-profit organization that is sponsored by the corporation and donates the earned Philas to either the same non-profit organization or the one that the corporation's wishes to contribute to.

A philanthropic corporation may choose to relax the conditions and encourage its employees to do social good on a global scale by providing them with grants depending on their level of charitable contributions or volunteering, and give them the choice to gift it to non-profits of their choice. Corporations may want to promote volunteering in the broader communities they serve by tapping not only their employees but also the citizens (consumers). Philanthropists and Foundations also may want to use these models to maximize the social impact of their spending on charity by choosing any of these modes.

Volunteers are benefited from the Philas as the system facilitates matching of the volunteer skills with the requirement of the non-profit organization. A benefit to all the stakeholders of this is the use of virtual currency in the form of Philas. Moreover the Philas can be tracked at every point of time and the principals who have pledged, the agents who are in possession of the Philas, the non-profit organizations who have redeemed the Philas can be identified. It is also possible to identify when and where the Philas were redeemed and/or donated.

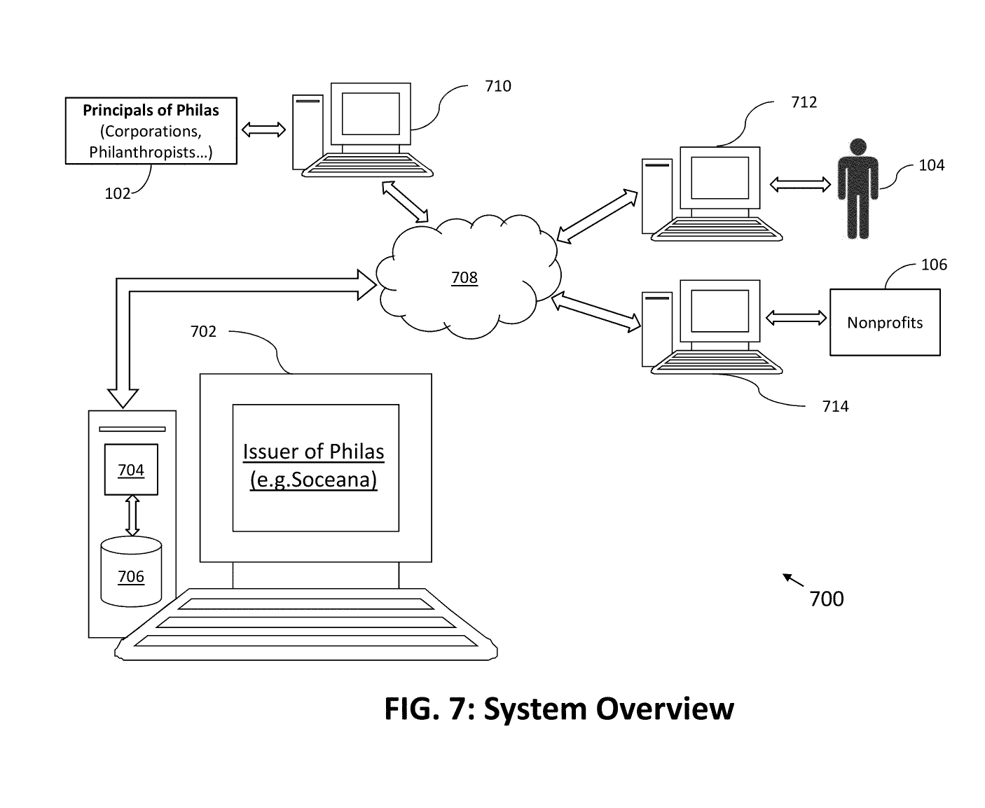

Referring now to FIG. 7, a schematic block diagram with an overview of system 700 for facilitating transactions of corporate social responsibility (CSR) and Social Good (SG) funds among corporations, philanthropists, volunteers, and non-profit organizations dedicated to social causes, using Philas, alternative currency units, in accordance with various embodiments of the present invention, is shown. The system 700 includes a central server 702, incorporating the Soceana technologies to support Philas. The central server 702 includes a processor 704 communicatively coupled to a memory 706, by using an appropriate arrangement, such as a bus and various interfaces (not shown). The central server 702 is further connected to a network 708, such as a local area network (LAN), metropolitan area network (MAN), and wide area network (WAN) or the Internet, over a secured communication channel. The data sent by the central server 702 may be suitably encrypted by using one or more cryptographic techniques well known in the art.

The system 700 further includes various client devices present with the various entities dedicated to social causes. For example, in FIG. 7, client devices 710, 712, and 714 are illustrated, which are respectively present with the principals (corporations or philanthropists) 102, volunteers 104, and non-profit organization 106. However, it will be apparent to a person skilled in the art that many more such client devices can be connected to the central server 702 by way of the network 708, and it does not restrict the scope of the present invention in any way. The principals 102, volunteers 104, and non-profits 106 interact with each other by way of the central server 702 and the network 708.

The processor 704 of the central server 702 is configured to read the data from, and write the data on to the memory 706. The processor 704 is further configured to execute the method of the present invention, as described in conjunction with FIGS. 1 and 4a-6b.

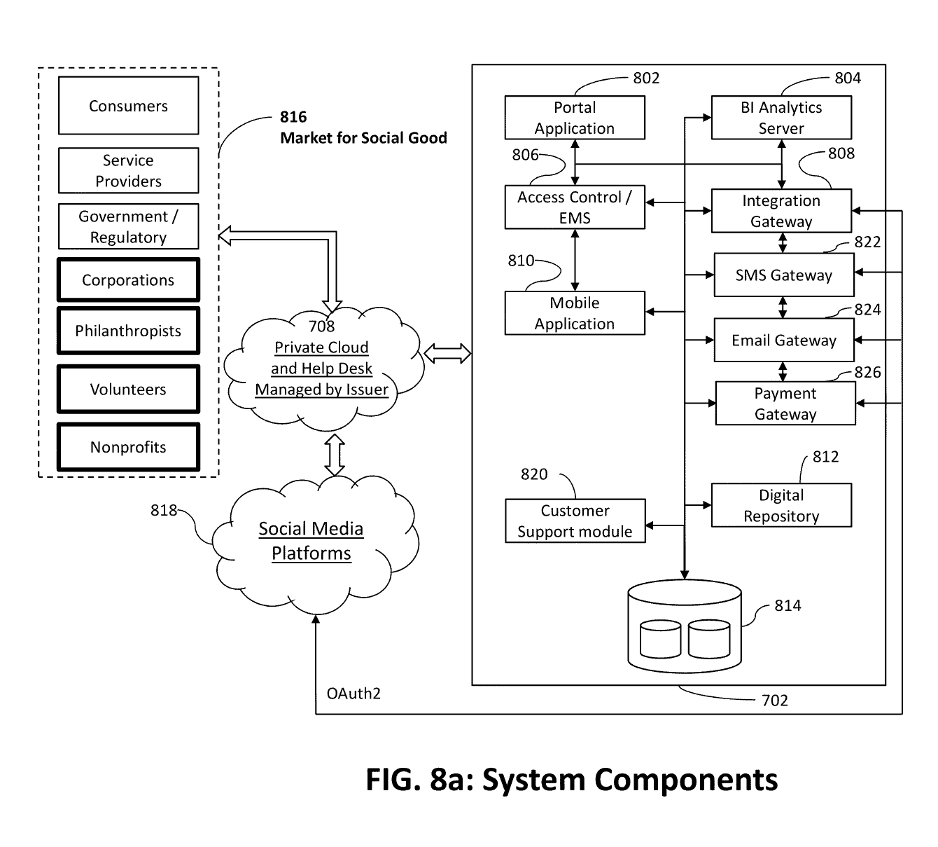

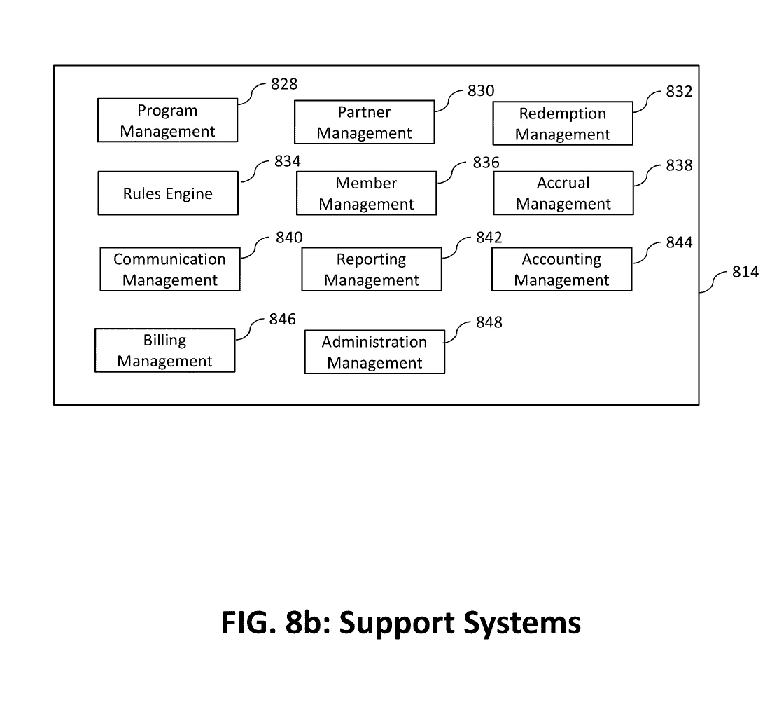

FIG. 8a illustrates a schematic block diagram of the system 800 with its components and support systems, in accordance with an alternative embodiment of the present invention. The central server 702 includes a portal application server 802, a Business Intelligence (BI) analytics server 804, an access control/Enterprise Management System (EMS) module 806, an integration gateway 808, a mobile application platform 810, a digital repository 812, a central database 814, a customer support module 820, a short service message (SMS) gateway 822, an electronic mail (email) gateway 824, and a payment gateway 826. The central server 702 is connected to the network 708, such as the Internet and interacts with various entities 816 participating in the market for social good, via the network 708. Further, the central server 702 is also connected to various social media platforms 818 by way of its integration gateway 808.

816 represents the participants or entities in the market for social good. It covers all the participants in the domain of corporate and individual philanthropy, including corporate social responsibility (CSR) and social good (SG), where the key stakeholders are corporations, philanthropists, volunteers, non-profits, governmental organizations, regulatory bodies (e.g. authorities who approve tax deductions), consumers, and service providers (e.g. Marketing companies).

The portal application server 802 is configured to generate and host portals that implement the methods of the present invention, such as a web based portal or a website of the issuer (Soceana). The portal application server 802 may further host a website of its partners that are engaged with the programs associated with Philas. The members i.e. entities that have registered at the issuer are enabled to access a member portal. The member portal displays various volunteering opportunities, an account view to view the Philas in the account, and so on to the volunteers. Corporations view their pledges and programs associated therewith at the member portal. Further, the volunteers may log the number of volunteer hours and/or cash gift contributed through the member portal. The portals serve as a front end (User Interface) for the various entities in the market for social good 816. Similarly, the mobile application platform 810 is configured to generate and host a mobile based application that serves as the user front end of user interface. A suitable graphical user interface (GUI) may be generated by the portal application server 802 and the mobile application platform 810. The portal application server 802 and the mobile application platform 810 may be implemented by using a suitable technology, such as jBOSS application server technology, Android, iOS, Linux, Unix, and the like.

The Access Control/EMS module 806 provides selective restriction of access to a place or other resource. The act of accessing may mean consuming, entering or using permission to access a resource. The enterprise management system (EMS) module 806 consists of systems and applications for managing and monitoring applications and network elements of the IT infrastructure.

The integration gateway 808 is communicatively coupled to the portal application server 802, the mobile application platform 810, the access control/EMS module 806, the BI analytics server 804, the customer support module 820, the SMS gateway 822, the email gateway 824, and the payment gateway 826 and facilitates the interaction of these components with the social media platforms 818. In an embodiment of the invention, the integration gateway is implemented by using a suitable services integration technology, such as jBOSS Fuse or Apache ServiceMix. It should be noted that the examples mentioned herein are for illustrative purpose. Any other suitable integration technology that handles various protocols and supports the services may also be used. Further, an appropriate authentication mechanism, such as OAUTH or OAUTH2 may be integrated between the integration gateway 808 and the social media platforms 818.

The BI analytics server 804 builds, schedules, secures, and distributes interactive, production-ready reports for various predictive analytics related to the method of the present invention. The principals may utilize the predictive analytics tool available at the issuer while configuring the Philas i.e. defining the parameters described in FIGS. 5 and 6a, and 6b. An important aspect to be considered while configuring the Philas is the feasibility of fullfilment of the pledges. For example, when parameters such as ‘window to earn’, ‘window to donate’, and ‘window to redeem’ are defined as one week, the time available for a volunteer or a non-profit is less. There is a high chance of volunteers not signing up for such programs that specify duration of one week to earn. Further, volunteers and non-profits are also given less time duration to donate or redeem the Philas. There is a need to select the most suitable parameters and further define those in a manner such that the social impact is good. The predictive analytics tool enables principals to select and define parameters and view the impact of such a program in the social good domain. Further, the BI analytics server 804 fetches past data regarding the pledges and corresponding programs, and utilizes the data to predict the best way to configure the pledge to ensure that the most qualified volunteers sign up for the corresponding program. Also, the past data may be utilized to ensure that volunteers sign up in huge numbers. Thus, principals can select and define parameters for programs such that it has maximum social impact and has the “force multiplier effect”. In various implementations, the BI analytics server 804 may be implemented by using a suitable technology, such as, but not limited to, Jasper BI express, Eclipse BIRT, Jasper Reports, Pentaho, SpagoBI, Palo, and the like.

The customer support module 820 implements appropriate customer support methods for the various participants 816. For example, the customer support module 820 may implement voice, chat, video, or multimedia based interaction with a customer support executive. The customer support executive may be a human or a machine. For example, in various implementations, system such as Verint, Parature, Oracle, and the like.

The SMS gateway 822 facilitates the server 702 to send and/or receive SMS transmissions to and/or from a telecommunication network. The content of the SMS is obtained from the digital repository 812 and may be customized based on the recipient of the SMS. The SMS gateway 822 is further coupled to the email and payment gateway and supports media conversion from email and other formats.

The email gateway 824 enables the transmission and reception of emails between dissimilar mail systems. The payment gateway 826 is an application service provider service that authorizes and aids payment transactions of economic currency as well as Philas amongst the issuer, corporations, philanthropists, non-profits, and volunteers.

FIG. 8b illustrates the central database 814, in accordance with an embodiment of the present invention. The central database 814 includes various modules such as program management 828, partner management 830, redemption management 832, rules engine 834, member management 836, accrual management 838, communication management 840, reporting management 842, accounting management 844, billing management 846, and administration management 848 modules. The processor 704 fetches and executes these modules to perform the method of the present invention.

The program management module 828 includes various volunteering programs organized by non-profits and perhaps backed by corporations or philanthropists that the volunteers can view and opt to volunteer for. For example, a blood donation camp organized by Red Cross is a program.

The partner management module 830 includes the data related to the partners of the issuer that support the use of Philas. For example, United Airlines may partner with the issuer and encourage its customers to redeem air miles for Philas. The customers can then donate the Philas to a non-profit of their choice or an accredited non-profit.

The redemption management module 832 includes data associated with the redemption of Philas. The data may include a list of non-profits that redeemed Philas, the corresponding number of redeemed Philas, the date and time of redemption, the conditions associated with the redeemed Philas and the like. The rules engine module 834 includes the rules/conditions used to configure the Philas. The rules engine includes the various parameters described in FIGS. 5, 6a and 6b to generate conditioned/programmed Philas. The member management module 836 includes a list of all the corporations, philanthropists, individual volunteers, and the non-profits associated with the programs using Philas. The accrual management module 838 includes a list of the volunteers with the corresponding number of accrued the Philas along with the Philas ID to track the Philas. The communication management module 840 includes the emails that thank the stakeholders for their participation in the programs. Further, the communication management module 840 includes emails that create awareness about various programs among the volunteers. Awareness is created among non-profits and corporations also regarding causes that lack supply. The reporting management module 842 includes various reports related to all the proceedings of the various programs. The accounting management module 844 includes data related to processes of keeping financial accounts. The billing management module 846 generates bills associated with the expenses of the programs, sale, resale and redemption of Philas. The billing information may be provided to the partners and corporations. The administration management module 848 includes data related to administration activities of the issuer.

Various components of the systems (Philas) described above may be implemented in the form of software, a firmware, hardware or combinations thereof. The systems, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system includes a computer, an input device, and a display unit, and communicates over the Internet. The computer can incorporate a microprocessor. The microprocessor can be connected to a communication bus. The computer can also include a memory. The memory may include Random Access Memory (RAM) and/or Read Only Memory (ROM). The computer system can further incorporate a storage device. The storage device can include a hard disk drive or a removable storage drive, such as a floppy disk drive and/or an optical disk drive. Storage device can also be other similar means for loading computer programs or other instructions into the computer system.

The computer system executes a set of instructions that are stored in one or more storage elements, in order to process input data. The storage elements may also hold data or other information as required. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. The term logic may include for example, software, hardware and/or combinations of software and hardware.

Although illustrative embodiments of the present invention have been described herein with reference to the accompanying drawings, it is to be understood that the invention is not limited to those precise embodiments, and that various other modifications may be made by one skilled in the art without departing from the scope or spirit of the invention.

What is claimed is:

1. A method for improving social good, comprising:
creating finite units of a social currency by a processor of a computer server, wherein each unit has a face value and a store of value associated therewith;
storing the finite units of the social currency in a memory coupled to the processor;
enabling a principal to pledge and guarantee the finite number of social currency units at the computer server, wherein the finite number of social currency units is sponsored at a fraction of the face value associated with the finite number of social currency units;
enabling a volunteer to earn at least one social currency unit at the computer server;
enabling a non-profit organization to receive, pledge-back, trade, and redeem the at least one social currency unit at the computer server, wherein the volunteer contributes time and efforts at the non-profit organization to earn the at least one social currency unit, and wherein the time and efforts correspond to volunteer hours and a skill level of the volunteer, respectively;
enabling a validation of the volunteer hours and the skill level of the volunteer at the computer server;
enabling an assignment of the at least one social currency unit to the volunteer based on the validation, wherein the volunteer hours and the skill level are matched with the store of value of the social currency units at the computer server;
enabling a transfer of the at least one social currency unit from the principal to the volunteer based on the assignment;
restricting conversion of the at least one social currency unit by the volunteer for personal consumption; and
facilitating the principal to credit charitable funds to the non-profit organization in exchange of the at least one social currency unit at the computer server, wherein the at least one social currency unit is gifted by the volunteer to the non-profit organization, and wherein the credited charitable funds are equivalent of the face value associated with the at least one social currency unit;
wherein the principals include corporations and philanthropists, and the agents include volunteers and non-profit organizations.

2. The method of claim 1, further comprising methods to associate one or more conditions to the social currency unit to meet one or more social purposes.

3. The method of claim 1, further comprising methods to pledge, sponsor, guarantee, and program social currency units by at least one of the corporation and the philanthropist.

4. The method of claim 1, further comprising methods to enable a transfer of the gifted at least one social currency unit by the volunteer to other volunteers or to other non-profit organizations engaged in charitable purposes.

5. The method of claim 1, wherein the pledge is fulfilled by the principals corresponding to the social currency units transferred/gifted by the volunteer by directly transferring the cash or non-cash resources to the nonprofits.

6. The method of claim 1, further comprising of methods to enable pledging of non-cash resources to support social good activities by nonprofits.

7. The method of claim 1, wherein the social currency units in circulation may be bought and sold among principals, volunteers and the non-profit organizations in the market for social good, thereby providing liquidity for the social currency units.

8. The method of claim 1, wherein the issuer creates a market for social good through methods for issuing the pledged social currency units, tracking their status at each point, denominating them to meet specific purposes (like gifting), and valuing them, and setting exchange rates for purchase and resale.

9. The method of claim 1, wherein the social currency unit is configured by specifying two or more distinguishing characteristics associated with these units.

10. The method of claim 9, wherein the multiple distinguishing characteristics is selected from: principal, volunteer type; a match type; contribution type; a match rate; an earn rate; a match limit; a window to earn; earn type; a window to gift; a recipient; a certifier; a nonprofit recipient; a payment type; a participating merchant; a window to redeem; and a combination of two or more thereof.

11. The method of claim 1 further comprising storing a first record of the validation of the volunteer hours and the skill level of the volunteer, a second record of the assignment of the at least one of the social currency unit to the volunteer, and a third record of the credited charitable funds by the principal to the non-profit organization in exchange of the at least one social currency unit in the memory at the computer server.

12. The method of claim 1, wherein the volunteer hours and the skill level of the volunteer are validated by at least one of the non-profit organization, a non-profit certifying authority, a specific certifying authority, and the volunteer; and match rate is determined by at least one of a volunteer type and a location of the non-profit organization.

13. The method of claim 1, further comprising enabling transferring of the transferred at least one alternative currency unit by the non-profit organization to other volunteers or to other non-profit organizations engaged in charitable purposes.

14. A system for improving social good the system comprising:
a central server comprising a processor and a memory coupled to the processor, wherein the processor is configured for:
creating finite units of a social currency, wherein each unit has a face value and a store of value associated therewith;
storing the finite units of the social currency in the memory;
enabling a principal to sponsor, pledge and guarantee the finite number of social currency units, wherein the finite number of social currency units is sponsored at a fraction of the face value associated with the finite number of social currency units;
enabling a volunteer to earn at least one social currency unit;
enabling a non-profit organization to receive, pledge-back, trade, and redeem the at least one social currency unit, wherein the volunteer contributes time and efforts at the non-profit organization to earn the at least one social currency unit, and wherein the time and efforts correspond to volunteer hours and a skill level of the volunteer, respectively;
enabling a validation of the volunteer hours and the skill level of the volunteer;
enabling an assignment of the at least one social currency unit to the volunteer based on the validation, wherein the volunteer hours and the skill level are matched with the store of value of the social currency units;
enabling a transfer of the at least one social currency unit from the principal to the volunteer based on the assignment;
restricting conversion of the at least one social currency unit by the volunteer for personal consumption;
facilitating the principal to credit charitable funds to the non-profit organization in exchange of the at least one social currency unit at the computer server, wherein the at least one social currency unit is gifted by the volunteer to the non-profit organization, and wherein the credited charitable funds are equivalent of the face value associated with the at least one social currency unit; and
updating the memory based on at least the principalship of the social currency unit, the transfer of the social currency unit, the credit of the charitable funds, and the gifting of the social currency unit.

15. The system of claim 14 further comprising:
one or more client computers, each with the corporation, the philanthropist, the volunteer, and the non-profit organization, wherein each client computer is communicatively coupled to the central server and the corporation, the philanthropist, the volunteer, and the non-profit organization communicate with the central server by way of a corresponding client computer.

16. A method for improving social good, the method comprising:
creating finite units of a social currency by a processor of a computer server, wherein each unit has a face value and a store of value associated therewith;
storing the finite units of the social currency in a memory coupled to the processor;
enabling a principal to sponsor, pledge, configure and guarantee a first set of social currency units from the finite number of social currency units at the computer server, wherein the first set of social currency units is sponsored at a fraction of the face value associated with the first set of social currency units;
enabling a volunteer to earn the first set of social currency units at the computer server;
enabling a non-profit organization to receive, pledge-back, trade, and redeem the first set of social currency units at the computer server, wherein the volunteer contributes time and efforts at the non-profit organization to earn the first set of social currency units, and wherein the time and efforts correspond to volunteer hours and a skill level of the volunteer, respectively;
enabling a validation of the volunteer hours and the skill level of the volunteer at the computer server;
enabling an assignment of the first set of social currency units to the volunteer based on the validation, wherein the volunteer hours and the skill level are matched with the store of value of the social currency units at the computer server;
enabling a transfer of the first set of social currency units from the principal to the volunteer based on the assignment;
restricting conversion of the first set of social currency units by the volunteer for personal consumption;
facilitating the principal to credit charitable funds to the non-profit organization in exchange of the first set of social currency units at the computer server, wherein the first set of social currency units is gifted by the volunteer to a fellow volunteer or directly to the non-profit organization in any denomination, and wherein the credited charitable funds are equivalent of the face value associated with the first set of social currency units; and
enabling a sale of a second set of social currency units from the finite number of social currency units at the computer server from the principal to at least one of another principal and another non-profit organization, wherein a sale value of the second set of social currency units is determined based on multiple distinguishing characteristics,
wherein the principals include corporations and philanthropists, and the agents include volunteers and non-profit organizations.

17. The method of claim 16, wherein the non-profit organization resells the transferred first set of social currency units to other principals and nonprofits, and wherein a resale value of the first set of social currency units is based on the multiple distinguishing characteristics.

18. The method of claim 17, wherein the multiple distinguishing characteristics include one or more of: principal, volunteer type; a match type; contribution type; a match rate; an earn rate; a match limit; a window to earn; earn type; a window to gift; a recipient; a certifier; a nonprofit recipient; a payment type; a participating merchant; a window to redeem; and a combination of two or more thereof.

19. An apparatus for operating social and economic enterprises comprising:
a user interface; a set of algorithms; and a processor configured to:
create a finite unit of a social currency having a face value and a store of value associated therewith;
store the finite unit of the social currency in a memory coupled to the processor;
enable a principal to pledge and guarantee the finite number of social currency units at the computer server, wherein the finite number of social currency units is sponsored at a fraction of the face value associated with the finite number of social currency units;
enable a volunteer to earn at least one social currency unit;
enable an organization to receive, pledge-back, trade, and redeem the at least one social currency unit, wherein the volunteer contributes time and efforts at the organization to earn the at least one social currency unit;
validate the volunteer hours and the skill level of the volunteer;
enable an assignment of the at least one social currency unit to the volunteer based on the validation, wherein the volunteer hours and the skill level are matched with the store of value of the social currency units;
enable a transfer of the at least one social currency unit from the principal to the volunteer based on the assignment;
restrict conversion of the at least one social currency unit by the volunteer for personal consumption; and
credit charitable funds to the non-profit organization in exchange for the at least one social currency unit; wherein the at least one social currency unit is gifted by the volunteer to the organization, and wherein the credited charitable funds are equivalent of the face value associated with the at least one social currency unit; and
wherein the principals include corporations and philanthropists, and the agents include volunteers and organizations.

20. The apparatus of claim 19, wherein the apparatus is communicatively coupled to a central server and which is configured to communicate with a plurality of apparatus, and enables the issuer of the social currency units to issue, denominate, and value the social currency units using a dynamic algorithm based on the effects of distinguishing characteristics at each point in time.
